(19) United States
(12) Patent Application Publication
(10) Pub. No.: US 2013/0169165 A1
(43) Pub. Date: Jul. 4, 2013

(54) Multi-Phase Lighting Driver

(71) Applicants: Laurence P. Sadwick, Salt Lake City, UT (US); Neil J. Barabas, Chatsworth, CA (US)

(72) Inventors: Laurence P. Sadwick, Salt Lake City, UT (US); Neil J. Barabas, Chatsworth, CA (US)

(21) Appl. No.: 13/708,953

(22) Filed: Dec. 8, 2012

Related U.S. Application Data
(60) Provisional application No. 61/570,986, filed on Dec. 15, 2011.

(51) Int. Cl. H05B 37/02

(52) U.S. Cl. CPC H05B 37/02
USPC 315/152; 315/250

(57) ABSTRACT

A multi-phase lighting driver.

### CROSS REFERENCE TO RELATED APPLICATIONS

The present application claims priority to (is a non-provisional of) U.S. Pat. App. No. 61/570,986, entitled “Multi-Phase Lighting Driver”, and filed Dec. 15, 2011 by Sadwick et al, the entirety of which is incorporated herein by reference for all purposes.

### BACKGROUND

Electricity is generated and distributed in alternating current (AC) form, wherein the voltage varies sinusoidally between a positive and a negative value. However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V AC, both of which are often higher than may be desired for a high efficiency LED light. In addition, commercial and municipal voltage levels can be significantly above 240 V AC and up to or above 480 VAC. Some conversion of the available power may therefore be necessary or highly desired with loads such as an LED light. In addition, LEDs generally are current controlled, that is, they operate with constant current.

In one type of commonly used power supply for loads such as an LED, an incoming AC voltage is connected to the load and current is drawn only during certain portions of the sinusoidal waveform. For example, a fraction of each half cycle of the waveform may be used by connecting the incoming AC voltage to the load each time the incoming voltage rises to a predetermined level or reaches a predetermined phase and by disconnecting the incoming AC voltage from the load each time the incoming voltage again falls to zero or capacitors that are used in the power supply circuit may charge only near the peak of, for example, the rectified AC input voltage. In this manner, a positive but reduced voltage may be provided to the load. This type of conversion scheme is often controlled so that a constant current is provided to the load even if the incoming AC voltage varies. However, if this type of power supply, and, often, other types of power supplies, with current control is used in an LED light fixture or lamp, a conventional dimmer is often ineffective. For many LED power supplies, the power supply will attempt to maintain the constant current through the LED despite a drop in the incoming voltage by increasing the on-time during each cycle of the incoming AC wave.

In a power supply for loads such as an LED, internal circuits or devices such as a variable pulse generator may derive power from a DC line. A need remains for a more efficient, flexible power source for internal circuits or devices that is able to meet all of the requirements, specifications, regulatory agency mandates, etc.

### SUMMARY

The lighting driver disclosed herein provides power for lights such as LEDs of any type and other loads.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments of the present invention may be realized by reference to the figures which are described in remaining portions of the specification. In the figures, like reference numerals may be used throughout several drawings to refer to similar components.

FIGS. 1 and 2 depict street lamps which include multi-phase lighting drivers in accordance with some embodiments of the present inventions;

FIG. 3 depicts a multi-phase lighting driver with multiple loads in accordance with some embodiments of the present inventions;

FIG. 4 depicts outputs from a pulse generator in a multi-phase lighting driver in accordance with some embodiments of the present inventions; and

FIG. 5 depicts a multi-phase lighting driver with a load in accordance with some embodiments of the present inventions.

### DESCRIPTION

The lighting driver disclosed herein provides power for lights such as LEDs of any type and other loads. The lighting driver may be dimmed or otherwise controlled externally, for example by controlling a line voltage supplying the lighting driver, or internally, for example using a wireless controller to command internal dimming circuits, etc. In addition, a wired or powerline control/command either digital or analog (or both) can be used with the present invention to dim. In some embodiments, the lighting driver is applicable to lighting systems such as street lamps, parking lot lamps, door lighting, commercial and residential lighting both outdoor and indoor, etc. In other embodiments, the present invention may be used for entertainment, architectural and other applications. The present invention is applicable to more than just dimmable LED drivers and power supplies and can, for example be applied to other types of LED and lighting drivers, power supplies and ballasts, including but not limited to dimmable and non-dimmable LED, OLED, florescent lamps (FLs), compact FLs (CFLs), cold cathode FLs (CCFLs), high intensity discharge lamps (HIDs), AC to DC, AC to AC, DC to AC and DC to DC low voltage lighting power converters and inverters and other types of power supplies for a wide, diverse and general use, including but not limited to, battery chargers, laptop power supplies, television and computer power supplies, AC to DC power supplies, AC to AC power supplies, DC to DC power supplies and DC to AC power supplies and, in general inverters and converters and power supplies of all types including isolated and non-isolated power supplies.

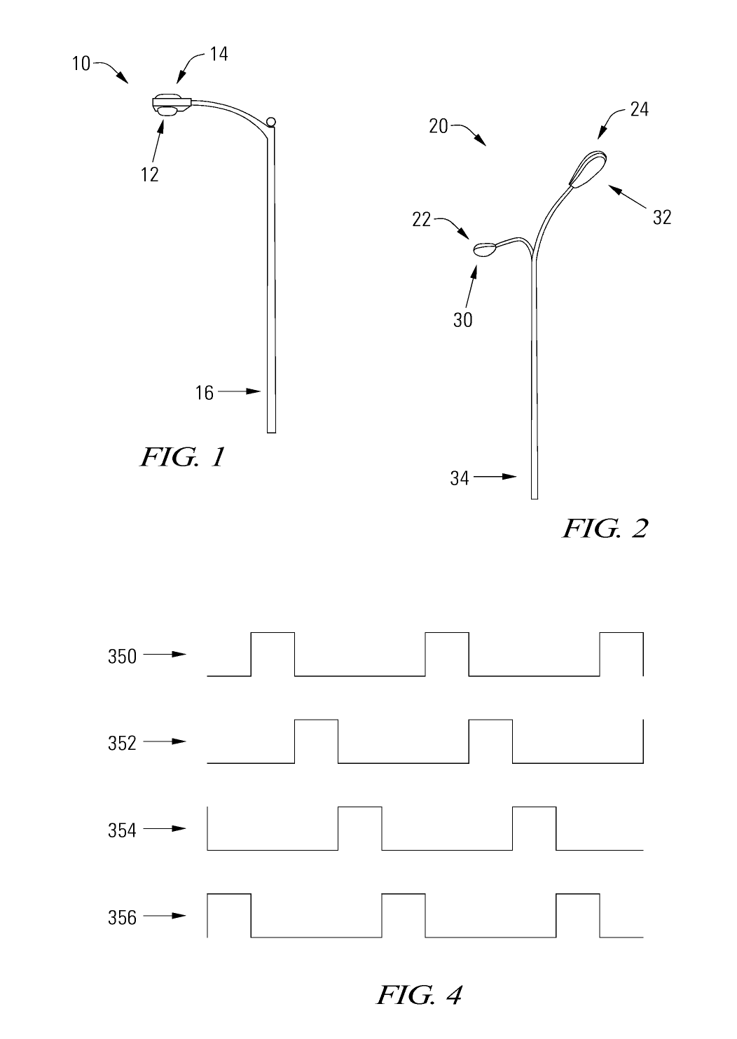

As an example, a street lamp 10 is illustrated in FIG. 1, in which one or more LED lamps 12 are provided, in one or more colors. A multi-phase driver is provided in the street lamp 10, for example in the head 14 of the street lamp 10 or in a cavity in the support pole 16. As another example, a dual outdoor light 20 is illustrated in FIG. 2 such as may be used to illuminate a parking lot. Each of the heads 22 and 24 may include one or more LED lamps 30 and 32, again in one or more colors. A multi-phase driver may be provided in each of the heads 22 and 24 or in a cavity in the support pole 34 to power the LED lamps 30 and 32, or a single multi-phase driver may power the LED lamps in both heads 22 and 24.

In some embodiments, the lighting driver is a multi-phase driver with multiple independently controllable channels, enabling for example a street lamp to include multiple color LEDs to provide for controllable color and intensity. Such a street lamp may be configured or programmed to provide colored lighting for festivities and holidays, or to be adapted to environmental conditions for safety. In some embodiments, the lighting driver includes environmental sensors, for example enabling a street lamp to automatically adjust a color and/or intensity in response to foggy, rainy or snowy conditions, etc.

Benefits and applications of the multi-phase lighting driver include the following:

Color changing street lamps, parking lot, outdoor lighting, wall, building, and associated, related, etc. lighting to adapt to, modify for, respond to, provide for, etc., for example, but not limited to:
Fog
Rain
Snow
Dust
Temperature
Weather, in general
Displays
Emergencies
Weather conditions
The presence of people, cars, trucks, vehicles, in general
Celebrations
Holidays
Festivities
Special events
Time of day or night
Needs at the time, etc.
Can be remote controlled
wired, wireless, powerline
programmable
dimmed by analog, digital, PWM, etc.
Step and continuous dimming
On/off
Can use sunlight, solar, batteries, vibrational, mechanical, thermal, etc. energy
Can have White plus one or more (i.e., multiple) colors LEDs
Can have more than White on at one time and more than one color, etc. LEDs
Can be synchronized for music, seasonal events and holidays (i.e., Christmas), etc.
Can use web, cellular phones, smart phones, light sensors, tablets such as, for example, ipads, ipods, droids, kindle, etc., motion sensors, etc.
Can turn, for example, every other LED or every other bank (group) of LEDs on or off to effectively dim or decrease light output
Can have a flicker mode or modes to simulate candle light, etc.
Can be individually/independently controlled or group controlled (i.e., one or all).

Can dim down in any desired manner and in any specified controlled way. For example, the present invention can be made to dim down slowly to adjust and respond to ambient light level changes, to respond to no human (i.e., foot) or vehicle travel, etc. Conversely, the present invention can also increase the light in any desired manner, going from zero or a lower intensity light output to a higher or full output based on, for example, responses to stimuli such as motion sensors and detectors, light sensors and detectors, sound and audio sensors and detectors, vibration sensors and detectors, etc. in addition to commands and control and other programmed and programmable information, etc.

High Power Factor

Power supply/driver can be built in blocks and the blocks can be set at different phases to each other.

Modular and Field Replaceable.

Can have over-voltage protection (OVP), over-current protection (OCP), over-temperature protection (OTP), short circuit protection (SCP), etc.

The OTP can be a ramping down of the output power when a over temperature is detected in, for example, the power-supply/driver, the LED, the ambient or some other temperature. The ramping down of the output power with temperature can be gentle, rapid, instantaneous, slow, immediate, fully-off, etc. Such OTP protection can be hard wired, programmable, user decided, automatically decided, overwritten-capable, flexible, etc. Any and all faults conditions including, but not limited to OVP, OCP, OTC, etc. can be reported both locally and remotely and appropriate measures and responses taken by any combination of automatic, manual, local, remote actions, etc. Can be isolated or non-isolated. The present invention can respond instantaneously, in a delayed mode, in a gradual mode, in a complete and instantaneous mode, in a dimming mode, etc. The present invention can turn off one or more of the multi-phases/multichannels to effectively dim and decrease the output power and light or can dim each multi-phase/multichannel either at the same level or different levels. The present invention can have separate outputs or combined or parallel outputs. The present invention can be implemented such that if one or more of the multi-phase/multichannel(s) should have a fault or fail, the remaining channels can adjust and accommodate for this fault or fail condition/situation.

The street lamp and other applications may be applied to driver circuits and applications such as the various dimmable LED drivers and their variations disclosed in U.S. patent application Ser. No. 12/422,258, filed Apr. 11, 2009 for a “Dimmable Power Supply”, and in U.S. patent application Ser. No. 12/776,409, filed May 9, 2010 for a “LED Lamp with Remote Control”, which are incorporated herein by reference for all purposes.

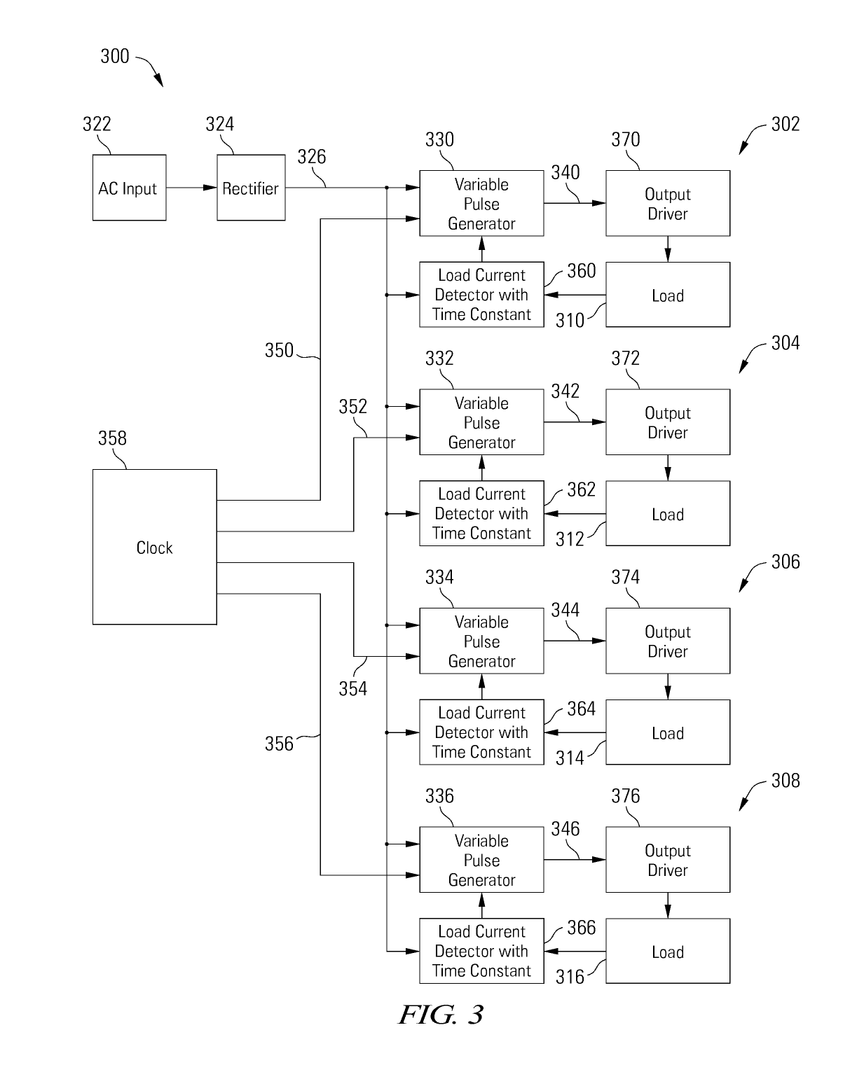

Turning to FIG. 3, a block diagram of an example embodiment of a multi-phase lighting driver 300 is illustrated. In this embodiment, four channels 302, 304, 306, 308 in the multi-phase are provided to independently power and control four loads 310, 312, 314, and 316. For example, each of the four loads 310-316 may comprise one or more LEDs of different colors, with each containing white, red, blue and green LEDs, respectively. This allows the intensity and overall color to effectively be controlled in a continuously variable manner. Multi-phase lighting driver 300 is powered by an AC input 322, for example by a 50 or 60 Hz sinusoidal waveform of 120 V or 240 V RMS or higher such as that supplied to commercial and residential facilities by municipal electric power companies. It is important to note, however, that the dimmable power supply 300 is not limited to any particular power input. Furthermore, the voltage applied to the AC input 322 may be externally controlled, such as in an external dimmer (not shown) that reduces the voltage. The AC input 322 is connected to a rectifier 324 to rectify and invert any negative voltage component from the AC input 322. Although the rectifier 324 may filter and smooth the power output 326 if desired to produce a DC signal, this is not necessary and the power output 326 may be a series of rectified half sinusoidal waves at a frequency double that at the AC input 322, for example 120 Hz. Each of the channels 302-308 contains a variable pulse generator 330, 332, 334, and 336, powered by the power output 326 from the AC input 322 and rectifier 324 to generate a train of pulses at outputs 340, 342, 344 and 346, respectively. The variable pulse generators 330-336 generate pulses at outputs 340-346 based on clock signals 350, 352, 354 and 356 from multi-phase clock 358. In other embodiments, a shared variable pulse generator generates multi-phase pulses to control a plurality of output drivers.

As illustrated in FIG. 4, clock signals 350-356 may comprise non-overlapping signals to trigger the different output channels 302-308, enabling independent switching of current to loads 310-316 from power line 326. The clock 358 may be, for example (but not limited to), a ring oscillator or delay locked loop producing four output phases. Using waveforms such as these, the multi-phase lighting driver provides excellent efficiency and power factor, drawing power in a substantially continuous manner from the line and appearing to be a resistive load.

The pulse width of the pulses in outputs 340-346 is controlled in the variable pulse generators 330-336 by load current detectors 360, 362, 364 and 366 based on load current levels. Various implementations of pulse width control including pulse width modulation (PWM) by frequency, analog and/or digital control may be used to realize the pulse width control. Other features such as soft start, delayed start, instant on operation, etc. may also be included if deemed desirable, needed, and/or useful. Output drivers 370, 372, 374 and 376 produce currents through the loads 310-316, with the current levels adjusted by the pulse widths at the outputs of the variable pulse generators 330-336. The load currents are monitored by the load current detector 360-366 and may also be monitored by a master load current detector sensor. Such a sensor could be, but is not limited to, a sense resistor, a sense transformer, a winding on a transformer or inductor, sensing via passive and/or active components, etc. The present invention, in addition to being powered by AC, can also be powered by direct current (DC) including DC input voltages.

The variable pulse generators 330-336, the output drivers 370-376, a controller (not shown) or other component is programmable in some embodiments to selectably output a desired color, shifting color pattern or light intensity by adjusting the pulse widths at the outputs of the variable pulse generators 330-336. In some embodiments, the output intensity and/or color is also adapted based at least in part on the output of one or more environmental sensors. For example, the color and/or intensity can be programmed to change based on the presence of fog or dust in the air, for example shifting from a white light to a yellow light in the presence of fog.

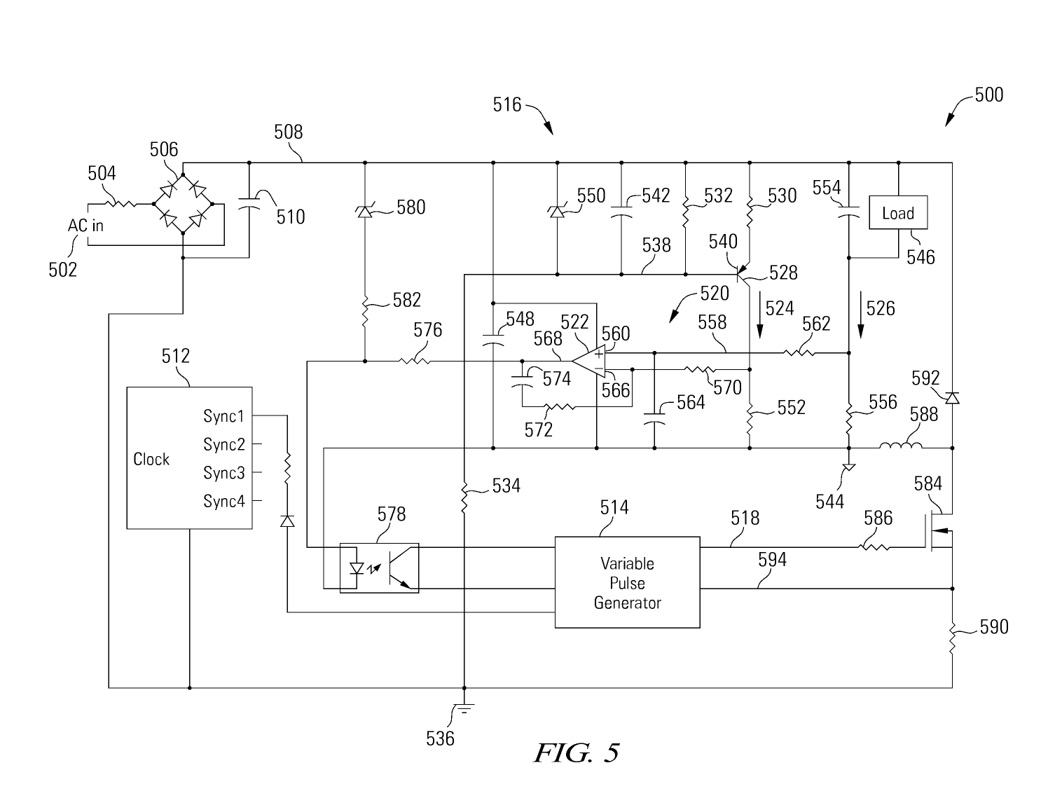

Turning now to FIG. 5, a schematic of one embodiment of the multi-phase lighting driver 500 will be described. Notably, a number of optional elements are included in the example multi-phase lighting driver 500 that may be omitted without departing from the inventive concepts disclosed herein. In this embodiment, an AC input 502 is used, with a resistor 504 included as a fuse, and a diode bridge as a rectifier 506. Some smoothing of the voltage on the supply rail 508 may be provided by a capacitor 510, although it is not necessary as described above. Capacitor 510 is optional and may be eliminated or reduced to a small value and, as mentioned above, is included as desired and or needed, etc.

A multi-phase clock 512 provides a number of output signals such as those illustrated in FIG. 4, with one providing the trigger or synchronization signal for variable pulse generator 514 in the channel 516 shown in FIG. 5. Additional channels (not shown), which may be duplicates of channel 516 or which may have some variations, are connected to the other outputs of multi-phase clock 512.

The variable pulse generator 514 generates pulses at the pulse output 518, triggered by or synchronized to the multi-phase clock 512, with the pulse width varied by one or more feedback signals as disclosed below or in other manners. The pulses from variable pulse generator 514 may have any suitable shape, such as substantially square or rectangular pulses, semi-sinusoidal, triangular, etc. although square or rectangular are perhaps most common in driving field effect transistors. The frequency of the pulses may also be set at any desired rate by multi-phase clock 512, such as 30 kHz or 100 kHz.

The width of the pulses may be controlled by load current detector 520, although a maximum width may be established if desired. The load current detector 520 includes an operational amplifier (op-amp) 522 acting as an error amplifier to compare a reference current 524 and a load current 526. The op-amp 522 may be embodied by any device suitable for comparing the reference current 522 and load current 526, including active devices and passive devices.

The reference current 522 may be supplied by a transistor such as bipolar junction transistor (BJT) 528 connected in series with resistor 530 to the supply rail 508. Resistors 532 and 534 are connected in series between the supply rail 508 and the circuit ground 536, forming a voltage divider with a central node 538 connected to the base 540 of the BJT 528. The BJT 528 and resistor 530 act as a constant current source that is varied by the voltage on the central node 538 of the voltage divider 532 and 534, which is in turn dependent on the input voltage at supply rail 508. A capacitor 542 may be connected between the supply rail 508 and the central node 538 to form a time constant for voltage changes at the central node 538. This approach also supports and facilitates dimming including wall and triac dimming. Other implementations may include a bandgap voltage reference, a high precision voltage reference, a Zener-based voltage reference, a voltage regulator, a voltage divider, etc. and/or any combination of such references. The multi-phase lighting driver 500 thus responds to the average voltage of supply rail 508 rather than the instantaneous voltage although the lighting driver can be designed to respond to the instantaneous voltage and/or both the instantaneous and average voltage or any combination, etc.

In one particular embodiment, the local ground 544 floats at about 10 V below the supply rail 508 at a level established by the load 546. A capacitor 548 may be connected between the supply rail 508 and the local ground 544 to smooth the voltage powering the load current detector 520 if desired. A Zener diode 550 may also be connected between the supply rail 508 and the central node 538 to set a maximum load current 526 by clamping the reference current 524 that BJT 528 can provide to resistor 552. In other embodiments, the load current detector 520 may have its current reference derived by a simple resistive voltage divider, with suitable AC input voltage sensing, level shifting, and maximum clamp, rather than BJT 528.

The load current 526 (meaning, in this embodiment, the current through the load 546 and through the capacitor 554 connected in parallel with the load 546) is measured using the load current sense resistor 556 although any current sensing element, including but not limited to a transformer or winding on a transformer or inductor, may be used in place of or in addition to sense resistor 556. The current measurement 558 is provided to an input of the error amplifier 522, in this case, to the non-inverting input 560. A time constant is applied to the current measurement 558 using any suitable device, such as the RC lowpass filter made up of the series resistor 562 and the shunt capacitor 564 to the local ground 544 connected at the non-inverting input 560 of the error amplifier 522.

As discussed above, any suitable device for establishing the desired time constant may be used such that the load current detector 520 disregards rapid variations in the load current 526 due to the pulses from the variable pulse generator 514 and any regular waveform on the supply rail 508. The load current detector 520 thus substantially filters out changes in the load current 526 due to the pulses, averaging the load current 526 such that the load current detector output 568 is substantially unchanged by individual pulses at the variable pulse generator output 514.

The reference current 524 is measured using a sense resistor 552 connected between the BJT 528 and the local ground 544, and is provided to the inverting input 566 of the error amplifier 522. The error amplifier 522 is connected as a difference amplifier with negative feedback, amplifying the difference between the load current 526 and the reference current 524. An input resistor 570 is connected in series with the inverting input 566. A feedback resistor 572 is connected between the output 568 of the error amplifier 520 and the inverting input 566. A capacitor 574 is connected in series with the feedback resistor 572 between the output 568 of the error amplifier 520 and the inverting input 566. An output resistor 576 is connected in series with the output 568 of the error amplifier 520 to further establish a time constant in the load current detector 520. Again, the load current detector 520 may be implemented in any suitable manner to measure the difference of the load current 526 and reference current 524. A level shifter 578, in this case, an opto-isolator, is connected to the output resistor 576 of the load current detector 520 to reference the output signal to the circuit ground 536 rather than the local ground 544. In other embodiments a level shifter and/or opto-isolator is not required.

A Zener diode 580 and series resistor 582 may be connected between the supply rail 508 and the output of output resistor 576 for overvoltage protection. Such an overvoltage protection can include a Zener diode of suitable voltage that can be fed to an appropriate input such as, for example, an optocoupler, optoisolator, BJT or FET that is fed to the feedback point of the pulse generator/circuit.

Pulses from the variable pulse generator 514 turn on a switch 584, in this case a power FET via a resistor 586 to the gate of the FET 584. This allows current 526 to flow through the load 546 and capacitor 554, through the load current sense resistor 556, inductor 588, the switch 584 and a current sense resistor 590 to circuit ground 536. In between pulses, the switch 584 is turned off, and the energy stored in the inductor 588 (or, in other embodiments, a transformer) when the switch 584 was on is released to resist the change in current. The current from the inductor 588 then flows through diode 592 and back through the load 546 and load current sense resistor 556 to the inductor 588. Because of the time constant in the load current detector 520, the load current 526 monitored by the load current detector 520 is an average of the current through the switch 584 during pulses and the current through the diode 592 between pulses.

The current through the channel 516 of the multi-phase lighting driver 500 is monitored by the current sense resistor 590, with a current feedback signal 594 returning to the variable pulse generator 514. If the current exceeds a threshold value, the pulse width is reduced or the pulses are turned off in the variable pulse generator 514.

In some embodiments, the multi-phase lighting driver obtains power for internal components such as the clock 358 and the variable pulse generators 330-336 using a tag-along inductor as disclosed in U.S. Patent Application 61/558,512, filed Nov. 11, 2011 for a “Dimmable LED Driver with Multiple Power Sources”, which is incorporated herein by reference for all purposes. One or more tag-along inductors may be connected in one or more of the output drivers 370-376. Additional power may be supplied from other sources such as snubbers and clamps and other types of energy storage devices and components including but not limited to inductors or capacitors of any type and combinations of these. As mentioned above batteries, solar cells, photovoltaics, vibrational, mechanical, heat, thermal, wired, wireless, RF, etc. sources of energy may also be used with the present invention. In some configurations the EMI filter may be used as a power source.

The present invention can be used in high power factor (PF) circuits with or without dimming including triac, forward and reverse dimmers, 0 to 10 V dimming, powerline dimming, wireless and other wired dimming, DALI dimming, PWM dimming, DMX, etc., as well as any other dimming and control protocol, interface, standard, circuit, arrangement, hardware, etc.

The example embodiments disclosed herein illustrate certain features of the present invention and not limiting in any way, form or function of present invention. Note that linear or switching voltage or current regulators or any combination can be used in the present invention and other elements/components can be used in place of the diodes, etc.

The present invention can monitor the current through all of the multi-phases/multi-channels or only one or more of the multi-phases/multichannels. The control/protection for the present invention can monitor/control/respond/act on/etc. Faults, inputs, feedback, responses, etc. from one of more of the multiphases/multi-channels. A microcontroller(s), microprocessor(s), FPGA(s), and/or analog or digital (or both) circuits can be used in the present invention for, for example, the fault detection, monitor, control, etc. and, for example, to dim or turn off individual channels.

The present invention may also reduce EMI, reduce ripple currents, improved power factor, power combine, reduce part counts. In addition, the present invention can use a single input full wave bridge or separate full bridges for the multiphase/multi-channels. In addition, a primary current limit sense can be included if desired in the present invention. The current sense could be a resistor, a current transformer, a current sense transformer, a winding, etc. that, for example, is fed to the appropriate point in the feedback/control of implementations of the present invention.

Although the discussion of the present invention, has primarily focused on 4 multi-phase/multi-channels, the present invention equally applies to N (where N is the number of multi-phases/multichannels) multi-phases such that N can be lower or higher than N=4; in other words the present invention is applicable to any implementation where N is greater than 1.

The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs), heterojunction bipolar transistors (HBTs), high electron mobility transistors (HEMTs), unijunction transistors, modulation doped field effect transistors (MODFETs), etc., again, in general, n-channel or p-channel or both, vacuum tubes including diodes, triodes, tetrodes, pentodes, etc. and any other type of switch, etc. The present invention can, for example, be used with any type of power supply configuration and topology, including but not limited to, continuous conduction mode (CCM), critical conduction mode (CRM), discontinuous conduction mode (DCM), resonant modes, etc., of operation with any type of circuit topology including but not limited to buck, boost, buck-boost, boost-buck, cuk, etc., SEPIC, flyback, forward converter, etc. In addition, the present invention does not require any additional special isolation or the use of an isolated power supply, etc. The present invention applies to all types of power supplies and sources and the respective power supply(ies) can be of a constant frequency, variable frequency, constant on time, constant off time, variable on time, variable off time, etc. Other forms of sources of power including thermal, optical, solar, radiated, mechanical energy, vibrational energy, thermionic, etc. are also included under the present invention. The present invention may be implemented in various and numerous forms and types including those involving integrated circuits (ICs) and discrete components and/or both. The present invention may be incorporated, in part or whole, into an IC, etc.

The present invention supports all standards and conventions for 0 to 10 V dimming or other dimming techniques. In addition the present invention can support, for example, overcurrent, overvoltage, short circuit, and over-temperature protection.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

When the temperature rises at the selected monitoring point(s), the phase dimming of the present invention can be designed and implemented to drop, for example, by a factor of, for example, two. The output power, no matter where the circuit was originally in the dimming cycle, will also drop/decrease by a some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may provide thermal control or other types of control to, for example, a dimming LED driver. For example, the circuit of FIGS. 1 and 2 or variations thereof may also be adapted to provide overvoltage or overcurrent protection, short circuit protection for, for example, a dimming LED driver, or to override and cut the phase and power to the dimming LED driver(s) based on any arbitrary external signal(s) and/or stimulus. The present invention can also include circuit breakers including solid state circuit breakers and other devices, circuits, systems, etc. That limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design etc., topology, implementation, etc.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for powering at least one load, comprising:
a power input;
a plurality of load outputs;
a plurality of output drivers operable to transfer current from the power input to the plurality of load outputs;
a plurality of pulse generators operable to control the plurality of output drivers to transfer the current from the power input to the plurality of load outputs with phase control.

2. The apparatus of claim 1, wherein the plurality of pulse generators are operable to cause the plurality of output drivers to transfer the current from the power input to the plurality of load outputs at different time periods.

3. The apparatus of claim 2, wherein the different time periods are non-overlapping.

4. The apparatus of claim 1, further comprising a clock source operable to provide a plurality of clock signals operable to enable the pulse generators to cause the output drivers to transfer the current from the power input to each of the plurality of load outputs at different times.

5. The apparatus of claim 4, wherein the clock source comprises a multi-phase clock circuit.

6. The apparatus of claim 5, wherein the multi-phase clock circuit comprises a ring oscillator.

7. The apparatus of claim 5, wherein the multi-phase clock circuit comprises a delay locked loop.

8. The apparatus of claim 1, wherein the apparatus is implemented as an integrated circuit.

9. The apparatus of claim 1, wherein the apparatus is implemented as a streetlamp.

10. The apparatus of claim 1, wherein at least some of the plurality of output drivers are operable to power different colored lights connected to each of the plurality of load outputs.

11. The apparatus of claim 1, wherein the plurality of pulse generators each comprise control inputs, and wherein the plurality of pulse generators are operable to control current levels to the plurality of load outputs based at least in part on the control inputs.

12. The apparatus of claim 11, wherein the plurality of output drivers each comprise a load current feedback signal output connected to a corresponding one of the control inputs.

13. The apparatus of claim 11, wherein the plurality of pulse generators and the plurality of output drivers are operable to dim lights that are connected to the plurality of load outputs.

14. The apparatus of claim 1, further comprising a sensor operable to cause the plurality of pulse generators to control current levels to the plurality of load outputs based at least in part on an output of the sensor.

15. The apparatus of claim 14, wherein the sensor comprises an element selected from the group consisting of a light sensor, a humidity sensor, a moisture sensor, a proximity sensor and an acoustic sensor.

16. The apparatus of claim 14, wherein the plurality of pulse generators are programmable to set the current levels to the plurality of load outputs to predetermined settings based at least in part on the output of the sensor.

17. A method of driving a plurality of current outputs comprising:
controlling a pulse width in a plurality of pulse streams, wherein each of the plurality of pulse streams is out of phase with the others;
controlling a plurality of output drivers with the pulse streams to control a flow of current from a power input to each of a plurality of load outputs; and
storing power from the flow of current in each of the plurality of output drivers when a corresponding one of the plurality of pulse streams is on and releasing the stored power when the corresponding one of the plurality of pulse streams is off.

18. The method of claim 17, further comprising generating a multi-phase clock signal to trigger at least one pulse generator to provide the plurality of pulse streams.

19. The method of claim 17, further comprising dimming the plurality of load outputs based at least in part on a dimming control signal.

20. The method of claim 17, further comprising adjusting the pulse width in the plurality of pulse streams based at least in part on an environmental sensor.
